(19) United States
(12) Patent Application Publication
(10) Pub. No.: US 2009/0088483 A1
(43) Pub. Date: Apr. 2, 2009

(54) AQUEOUS SUSPENSIONS OR DISPERSIONS OF INORGANIC PIGMENTS CONTAINING A MIXTURE CONSISTING OF DIALDEHYDES AND FORMALDEHYDE CLEAVERS

(76) Inventors: Willem Anker, Ellerbek (DE); Marc Hombeck, Hamburg (DE); Louise Sander Hansen, Hamburg (DE)

Correspondence Address: GREENBLUM & BERNSTEIN, P.L.C., 1950 ROLAND CLARKE PLACE, RESTON, VA, 20191, US

(21) Appl. No.: 11/909,254

(22) PCT Filed: Mar. 21, 2006
(86) PCT No.: PCT/EP2006/002600

§ 371 Date: Aug. 22, 2008

(30) Foreign Application Priority Data
Mar. 21, 2005 (DE) 102005013695.8

(51) Int. Cl. A01N 35/02

(52) U.S. Cl. 514/705

(57) ABSTRACT

The invention relates to aqueous suspensions or dispersions (slurries) of minerals and/or fillers and/or pigments containing one or more dialdehydes and one or more formaldehyde cleavers, and to the use of mixtures consisting of one or more dialdehydes and of one or more formaldehyde cleavers for stabilizing aqueous suspensions or dispersions of minerals and/or fillers and/or pigments (slurries) with regard to infestation or deterioration by microorganisms.

The present invention relates to aqueous suspensions or dispersions (=“slurries”) of minerals and/or fillers and/or pigments containing one or more dialdehydes and one or more formaldehyde cleavers, and the use of mixtures of one or more dialdehydes and one or more formaldehyde cleavers for stabilizing aqueous suspensions or dispersions of minerals and/or fillers and/or pigments (“slurries”) against attack or spoilage by microorganisms.

For the paper and cardboard industry, a considerable number of pigments is available both as filler and for surface treatment (“coating pigments”). By far the predominant proportion thereof is of natural origin, formed by inorganic processes and physically and chemically homogeneous as minerals. For special cases, however, organic products may also be used as “coating pigments”, e.g. plastic pigments.

Depending on requirements and cost-efficiency, different pigments are used, such as, for example, natural calcium carbonate (ground calcium carbonate=GCC), precipitated calcium carbonate (PCC), kaolin, talc, titanium dioxide and aluminum hydroxide, and in some special cases also satin white.

Coating pigments for the surface finishing of paper and cardboard have become established as one of the most important raw materials in the last 25 years, in addition to the fibers and fillers. The continuous development activity of various branches of industry are resulting in a substantial increase in the proportions of pigment in coated grades, with the result that the proportion of fiber can be reduced.

By coating with very high solids content (68-73%), so-called “high solids” coating, very high gloss and print gloss values are achieved. At the same time, a high degree of whiteness of the papers and optimum printability in offset printing are achieved therewith. In the cardboard sector, too, highly white calcium carbonate (CaCO₃) is now widely used.

From the individual formulation examples for offset papers and cardboards, it is evident that a distinction certainly has to be made regarding the paper grade for which the coating slips have to be conceived. In the case of matt papers, a distinction is made between single, double and triple coats, up to about 300 g/m² in the case of the latter for high-weight grades. Increasingly often, CaCO₃ is used in an amount of up to 100% as coating pigment; in various papers and cardboards, about 10-20% of talc or kaolin are concomitantly used, in particular in the topcoat. The fineness of the CaCO₃ in the case of matt qualities is generally 60-75% <2 pm. In gloss qualities, which are likewise produced with single, double or triple coats, coarser CaCO₃ qualities are to be found in the precoat. In single and topcoats, the fineness of the CaCO₃ is already in the range of 90-98%<2 μm.

Calcium carbonate slurries (suspension/dispersion) are by their very nature alkaline (pH 8-10) and are used worldwide in many millions of tons per year as filler and/or as coating pigment in the paper and cardboard industry.

The CaCO₃ slurries are prepared either by wet milling of marble/chalk/limestone (this quality is referred to as GCC=ground calcium carbonate) or by reaction of lime water with CO₂ (this quality is referred to as PCC: precipitated calcium carbonate). Depending on the production process and the pigment hardness high slurry temperatures occur during the production and may be 45-90° C. Owing to the large production volumes and the associated energy-intensive cooling processes, the slurries are not completely cooled down (also for cost reasons). As a result, temperatures of 35-65° C. are also often present in the storage tank of the finished slurry.

Under the general term calcite, natural calcium carbonate occurs as chalk, limestone and marble. Chalk is a weakly consolidated sedimentary rock having limited whiteness. Limestone on the other hand is more highly consolidated and whiter than chalk. Marble is a metamorphic carbonate rock which has formed by chemical recrystallization of chalk or limestone under high pressure and at high temperature.

The highest degree of whiteness among the natural carbonates can be achieved with marble. For this purpose, the GCC is processed in various ways depending on use; for example, dry milling and particularly wet milling are used for other purposes in each case. For the paper and cardboard industry, wet milling has become established because very great finenesses with targeted particle distribution curves can be achieved therewith. With solids contents of up to virtually 80%, these slurries are delivered directly to the paper and cardboard producers.

The GCC quality is generally produced in the vicinity of the limestone source and not necessarily in the vicinity of the paper mill. Delivery to the paper or cardboard mills takes place by means of railway, road tankers or ships. Additional intermediate stores, in the vicinity of the paper mills, then also ensure shorter-term deliveries.

The PCC quality is often produced in a factory directly adjacent to a paper mill and fed via a pipeline directly from the storage tank of the slurry producer to the paper process. Very short residence times of the slurry in the storage tank may occur here (6-12 hours) before it is used. On the other hand, other slurry qualities may also be stored for a much longer time in the tank before they are used (1-21 days). Deliveries to other, more remote paper mills may also take place.

Slurries in general and calcium carbonate slurries in particular are very susceptible to microorganisms.

A known preservative is glutaraldehyde (GDA). GDA is stable only in the acidic pH range (pH 3-5). In the alkaline pH range, the stability decreases very rapidly. This is even more substantially accelerated by temperatures>30° C.

GDA is capable of sanitizing a microbially contaminated (alkaline) slurry within 1-4 hours. However, GDA provides no long-term protection since the active substance GDA is completely degraded in the slurry after a few days.

An object of the present invention was therefore to provide slurries which can be rendered microbe-free in a short time but in which freedom from microbes is ensured even over a relatively long waiting period up to further processing.

This object is achieved, according to the invention, by aqueous suspensions or dispersions of minerals and/or fillers and/or pigments (“slurries”) containing
one or more dialdehydes
one or more formaldehyde cleavers.

Advantageously used dialdehydes are glutaraldehyde (GDA), orthophthalaldehyde (OPA) and glyoxal.

Preparations according to the invention are distinguished by good long-term stability to attack by microorganisms.

The use of mixtures of one or more dialdehydes and one or more formaldehyde cleavers for stabilizing aqueous suspensions or dispersions of minerals and/or fillers and/or pigments (“slurries”) to attack or spoilage by microorganisms is therefore also according to the invention.

Advantageously, the concentration of one or more dialdehydes in the aqueous suspensions or dispersions according to the invention can be chosen from the range from 0.0001 to 5.0% by weight, preferably from 0.0005 to 1.0% by weight, particularly preferably from 0.001-0.5% by weight, based on the total weight of the product to be protected.

Formaldehyde cleavers, such as, for example, (ethylenedioxy)dimethanol (also referred to as EDDM or O-formal) are stable in the alkaline pH range (7-10). Even elevated temperatures (50-80° C.) result in no significant decline in active substance over a period of a few days (the slurry also cools slowly after production; the storage tank volume may easily be 300-1000 tons or more).

Formaldehyde cleavers are resorted to if a microbicide which is less volatile, has less odor and is more stable than formaldehyde is needed. The first step on the route to these substances is the introduction of the hydroxymethyl group into molecules having active hydrogen atoms which can react with formaldehyde. Such molecules are to be found in a very wide range of classes of substances, starting with water and extending to amino acids.

The hydroxymethyl compounds obtained in this manner can further undergo intramolecular and intermolecular reactions with elimination of water, so that an enormous variety of formaldehyde cleavers having different physicochemical properties is available. These include solids or liquids having little odor, water-soluble and odor-soluble substances, and active substances which are alkaline, neutral or slightly acidic. Common to many of these substances is that, although they contain formaldehyde in bound form, they at the same time contain it in a form available for the antimicrobial effect, so that they can be used as electrophile-active active substances.

As a rule, formaldehyde cleavers have an antimicrobial effect if their formaldehyde content in aqueous solution can be determined by means of the method described by Tannenbaum and Bricker (reaction of the liberated formaldehyde with phenylhydrazine and potassium hexacyanoferrate).

With the aid of the formaldehyde cleavers, fields of use which otherwise remained closed owing to its unfavorable properties are opened up for formaldehyde as a microbicide. The antimicrobial formaldehyde cleavers can be divided into the following important main classes: hemiformals (O-hydroxymethyl compounds), C-hydroxymethyl compounds, amine-formaldehyde adducts and condensates and amide-formaldehyde adducts.

Formaldehyde cleavers which can advantageously be used in the context of the present invention are 1,3-bis(hydroxymethyl)urea, (ethylenedioxy)dimethanol, 2,2′,2″- (hexahydro-1,3,5-triazine-1,3,5-triyl)triethanol, tetrahydro-1,3,4,6-tetrakis(hydroxymethyl)imidazo[4,5-d]-imidazole-2,5-(1H,3H)-dione, α,α′,α″-trimethyl-1,3,5-triazine-1,3,5-(2H,4H,6H)-triethanol, 3,3′-methylenebis[5-methyloxazolidine]/oxazolidine, reaction products of N,N′-bis(hydroxymethyl)urea with 2-(2-butoxyethoxy)ethanol, ethylene glycol and formaldehyde, (benzyloxy)methanol, 4,4-dimethyloxazolidine, 7a-ethyldihydro-1H,3H,5H-oxazolo[3,4-c]oxazole, sodium N-(hydroxymethyl)glycinate, 1,3-bis(hydroxymethyl)-5,5-dimethylimidazolidine-2,4-dione, reaction products of ethylene glycol and formaldehyde, reaction products of tetrahydroimidazo[4,5-d]imidazole-2,5(1H,3H)-dione and formaldehyde, 1-[1,3-bis(hydroxymethyl)-2,5-dioxoimid-azolidin-4-yl]-1,3-bis(hydroxymethyl)urea/diazolidinyl-urea, cis-1-(3-chloroallyl)-3,5,7-triaza-1-azonia-adamantyl chloride, dazomet.

A preferred formaldehyde cleaver in the context of the present invention is (ethylenedioxy)dimethanol (EDDM).

Advantageously, the concentration of one or more formaldehyde cleavers in the aqueous suspensions or dispersions according to the invention can be chosen from the range from 0.0001 to 5.0% by weight, preferably from 0.001 to 1.0% by weight, particularly preferably 0.005-0.5% by weight, based on the total weight of the product to be protected.

Advantageously, the weight ratio of dialdehyde to formaldehyde cleaver can be chosen from the range from 50:1 to 1:1000, preferably from 10:1 to 1:100, particularly preferably from 5:1 to 1:20.

By the combined addition of GDA and EDDM, it is now possible for a microbe-free pigment slurry or pigment slurry having a low microbe content to be delivered either at room temperature or at elevated temperatures in a very short time (=rapid effect of the biocide), as well as to be kept over relatively long periods.

In addition, it was found that this combination has a substantially better effect than the individual substances, even at higher concentrations.

As is known to the person skilled in the art the main amount of customary slurries comprises as a rule from 25 to 80% by weight of very finely milled or comminuted pigment material, namely of the abovementioned inorganic pigments, according to the invention preferably calcium carbonate. The particle size is advantageously adjusted so that about 50-90% of the particles have a particle size<2 μm.

It is advantageous to incorporate further customary constituents into the slurry. To be singled out among these are dispersants, the purpose of which is to keep the dispersed particles in suspension. The dispersant is advantageously present in concentrations of 0.1-1.5% by weight. Polyacrylates are advantageously used but quaternary ammonium compounds are, if appropriate, also advantageous.

Particularly if hydrophobic pigments (such as, for example, talc or mica) are used, it may be advantageous additionally to use wetting agents. Polyethylene/polypropylene block copolymers are advantageous.

Furthermore, small amounts of antifoams, optical brighteners or flow improvers may be added.

It may furthermore be particularly advantageous in the context of the present invention to add further antimicrobial substances, for example 3-iodo-2-propynyl butylcarbamate (IPBC), bronopol or antimicrobial substances selected from the group of the isothiazolinones, in particular those selected from the group of 5-chloro-2-methylisothiazolin-3-one, 2-methylisothiazolin-3-one, 2-n-octylisothiazolin-3-one, 4,5-dichloro-2-n-octylisothiazolin-3-one, 1,2-benzisothiazolin-3-one, N-(C₁-C₁₂)-alkyl-1,2-benziso-thiazolin-3-one, preferably N-butyl-1,2-benzisothiazolin-3-one, to the slurries according to the invention.

It is advantageous to choose the concentration of. IPBC, bronopol or one or more isothiazolinones from the range from 0.00001 to 0.5% by weight, preferably from 0.00005 to 0.1% by weight, particularly preferably from 0.0001-0.01% by weight, based on the total weight of the aqueous suspensions or dispersions.

The following examples are intended to explain the invention.

### EXAMPLE 1

An aqueous suspension (pH 8.9) containing
76% of calcium carbonate (GCC)
0.35% of sodium polyacrylate
120 ppm of ethylenedioxy(dimethanol) (EDDM)
15 ppm of glutaraldehyde (GDA)
water to 100%

### EXAMPLE 2

An aqueous suspension (pH 9.8) containing
30% of calcium carbonate (PCC)
0.30% of sodium polyacrylate
80 ppm of ethylenedioxy(dimethanol)
10 ppm of glutaraldehyde
water to 100%

### Microbiological Results of This Suspension

Here, the quantitative test was carried out to determine how rapidly (1 hour to 7 days) the stated amounts of active substance reduce the microbial count of a microbially contaminated slurry. The microbial counts of the unpreserved slurry (=without biocide) show that the microbe spectrum in the slurry is capable of surviving.

| | 1 hour | 2 hours | 3 hours | 24 hours | 3 days | 7 days |
|---|---|---|---|---|---|---|
| without biocide | 3.2 * 10⁵ | 2.1 * 10⁵ | 2.5 * 10⁵ | 2.9 * 10⁵ | 4.5 * 10⁵ | 2.8 * 10⁵ |
| +100 ppm EDDM | 1.6 * 10⁵ | 1.7 * 10⁵ | 1.6 * 10⁵ | 3.4 * 10⁴ | 3.3 * 10⁴ | 5.6 * 10³ |
| +200 ppm EDDM | 1.6 * 10⁵ | 1.1 * 10⁵ | 1.2 * 10⁵ | 2.9 * 10⁴ | 2.3 * 10⁴ | 1.7 * 10³ |
| +10 ppm GDA | 1.2 * 10⁵ | 1.3 * 10⁴ | 2.6 * 10³ | <100 | 4.7 * 10² | 3.5 * 10⁵ |
| +20 ppm GDA | 2.2 * 10³ | 3.0 * 10² | <100 | <100 | <100 | 1.7 * 10³ |
| +80 ppm EDDM | <100 | <100 | <100 | <100 | <100 | <100 |
| +10 ppm GDA | | | | | | |

### EXAMPLE 3

An aqueous suspension (pH 10.1) containing
64% of talc
0.3% of sodium polyacrylate
1.4% of ethylene oxide/propylene oxide adduct (EO/PO adduct)
170 ppm of ethylenedioxy(dimethanol)
15 ppm of glutaraldehyde
water to 100%

### EXAMPLE 4

An aqueous suspension (pH 7.8) containing
60% of kaolin
0.35% of sodium polyacrylate
185 ppm of ethylenedioxy(dimethanol)
30 ppm of glutaraldehyde
water to 100%

1-9. (canceled)

10. An aqueous suspension or dispersion of one or more of minerals, fillers and pigments, wherein the suspension or dispersion comprises (a) one or more dialdehydes and (b) one or more formaldehyde cleavers.

11. The suspension or dispersion of claim 10, wherein (a) is present in a concentration of from 0.0001% to 5.0% by weight, based on a total weight of the suspension or dispersion.

12. The suspension or dispersion of claim 11, wherein (a) is present in a concentration of from 0.0005% to 1.0% by weight.

13. The suspension or dispersion of claim 11, wherein (a) is present in a concentration of from 0.001% to 0.5% by weight.

14. The suspension or dispersion of claim 10, wherein (b) is present in a concentration of from 0.0001% to 5.0% by weight, based on a total weight of the suspension or dispersion.

15. The suspension or dispersion of claim 14, wherein (b) is present in a concentration of from 0.001% to 1.0% by weight.

16. The suspension or dispersion of claim 14, wherein (b) is present in a concentration of from 0.005% to 0.5% by weight.

17. The suspension or dispersion of claim 10, wherein a weight ratio (a):(b) is from 50:1 to 1:1000.

18. The suspension or dispersion of claim 17, wherein a weight ratio (a):(b) is from 10:1 to 1:100.

19. The suspension or dispersion of claim 17, wherein a weight ratio (a):(b) is from 5:1 to 1:20.

20. The suspension or dispersion of claim 10, wherein (a) comprises one or more of glutaraldehyde, orthophthalaldehyde, and glyoxal.

21. The suspension or dispersion of claim 10, wherein (b) comprises one or more of 1,3-bis(hydroxymethyl)urea, (ethylenedioxy)dimethanol, 2,2′,2″-(hexahydro-1,3,5-triazine-1,3,5-triyl)triethanol, tetrahydro-1,3,4,6-tetrakis(hydroxymethyl)-imidazo[4,5-d]imidazole-2,5-(1H,3H)-dione, α,α″,α″-trimethyl-1,3,5-triazine-1,3,5-(2H,4H,6H)-triethanol, 3,3′-methylenebis[5-methyloxazolidine]/oxazolidine, reaction products of N,N′-bis(hydroxymethyl)urea with 2-(2-butoxyethoxy)ethanol, ethylene glycol and formaldehyde, (benzyloxy)methanol, 4,4-dimethyloxazolidine, 7a-ethyldihydro-1H,3H,5H-oxazolo[3,4-c]oxazole, sodium N-(hydroxymethyl)glycinate, 1,3-bis(hydroxymethyl)-5,5-dimethylimidazolidine-2,4-dione, reaction products of ethylene glycol and formaldehyde, reaction products of tetrahydroimidazo[4,5-d]imidazole-2,5(1H,3H)-dione and formaldehyde, 1-[1,3-bis(hydroxymethyl)-2,5-dioxoimidazolidin-4-yl]-1,3-bis(hydroxymethyl)urea/diazolidinylurea, cis-1-(3-chloroallyl)-3,5,7-triaza-1-azonia-adamantyl chloride, and dazomet.

22. The suspension or dispersion of claim 10, wherein the suspension or dispersion further comprises (c) one or more of 3-iodo-2-propynyl butylcarbamate, bronopol, and a isothiazolinone.

23. The suspension or dispersion of claim 22, wherein (c) comprises one or more of 5-chloro-2-methylisothiazolin-3-one, 2-methylisothiazolin-3-one, 2-n-octylisothiazolin-3-one, 4,5-dichloro-2-n-octylisothiazolin-3-one, 1,2-benzisothiazolin-3-one, and N-(C₁-C₁₂)-alkyl-1,2-benzisothiazolin-3-one.

24. The suspension or dispersion of claim 22, wherein (c) comprises N-butyl-1,2-benzisothiazolin-3-one.

25. The suspension or dispersion of claim 22, wherein (c) is present in a concentration of from 0.00001% to 0.5% by weight, based on a total weight of the suspension or dispersion.

26. The suspension or dispersion of claim 25, wherein (c) is present in a concentration of from 0.00005% to 0.1% by weight.

27. The suspension or dispersion of claim 25, wherein (c) is present in a concentration of from 0.0001% to 0.01% by weight.

28. An aqueous suspension or dispersion of one or more of minerals, fillers and pigments, wherein the suspension or dispersion comprises (a) from 0.001% to 0.5% by weight of one or more dialdehydes and (b) from 0.005% to 0.5% by weight one or more formaldehyde cleavers, each based on a total weight of the suspension or dispersion.

29. The suspension or dispersion of claim 28, wherein a weight ratio (a):(b) is from 5:1 to 1:20.

30. The suspension or dispersion of claim 29, wherein (a) comprises one or more of glutaraldehyde, orthophthalaldehyde, and glyoxal.

31. The suspension or dispersion of claim 29, wherein the suspension or dispersion further comprises (c) from 0.0001% to 0.01% by weight of one or more of 3-iodo-2-propynyl butylcarbamate, bronopol, and a isothiazolinone.

32. The suspension or dispersion of claim 31, wherein (c) comprises N-butyl-1,2-benzisothiazolin-3-one.

33. A method of protecting aqueous suspensions or dispersions of minerals and/or fillers and/or pigments against attack or spoilage by microorganisms, wherein the method comprises combining the aqueous suspension or dispersion with one or more dialdehydes and one or more formaldehyde cleavers.
